(19) United States
(12) Patent Application Publication
(10) Pub. No.: US 2005/0135516 A1
(43) Pub. Date: Jun. 23, 2005

(54) Dual antenna receiver for voice communications

(75) Inventors: Ronald D. Javor, Phoenix, AZ (US); Yoni Perets, Raanana (IL)

Correspondence Address: LeMoine Patent Services, PLLC;c/o PortfolioIP, P.O. Box 52050, Minneapolis, MN, 55402, US

(73) Assignee: Intel Corporation

(21) Appl. No.: 10/741,684

(22) Filed: Dec. 19, 2003

(51) Int. Cl. H04L 1/02; H04B 7/10

(52) U.S. Cl. 375/347

(57) ABSTRACT

A dual antenna receiver utilizes spatio-temporal processing in a packet-based network.

### FIELD

The present invention relates generally to wireless packet networks, and more specifically to voice communications in wireless packet networks.

### BACKGROUND

Wireless Voice-over-Packet Networks (VoPN) allow packetized voice calls to occur on wireless local area networks (WLAN) or cellular networks. In these networks, voice data is divided into packets, and the packets are transmitted. Many packet networks do not guarantee a minimum latency for packets, which may cause a problem for voice transmission. If one or more packets are delayed due to latency, the voice signal may not be faithfully reproduced on the receiving end of the wireless link.

### BRIEF DESCRIPTION OF THE DRAWINGS

FIG. 1 shows a dual antenna receiver;

FIG. 2 shows a Voice-over-IP architecture;

FIG. 3 shows a system diagram in accordance with various embodiments of the present invention; and

FIG. 4 shows a flowchart in accordance with various embodiments of the present invention.

### DESCRIPTION OF EMBODIMENTS

In the following detailed description, reference is made to the accompanying drawings that show, by way of illustration, specific embodiments in which the invention may be practiced. These embodiments are described in sufficient detail to enable those skilled in the art to practice the invention. It is to be understood that the various embodiments of the invention, although different, are not necessarily mutually exclusive. For example, a particular feature, structure, or characteristic described herein in connection with one embodiment may be implemented within other embodiments without departing from the spirit and scope of the invention. In addition, it is to be understood that the location or arrangement of individual elements within each disclosed embodiment may be modified without departing from the spirit and scope of the invention. The following detailed description is, therefore, not to be taken in a limiting sense, and the scope of the present invention is defined only by the appended claims, appropriately interpreted, along with the full range of equivalents to which the claims are entitled. In the drawings, like numerals refer to the same or similar functionality throughout the several views.

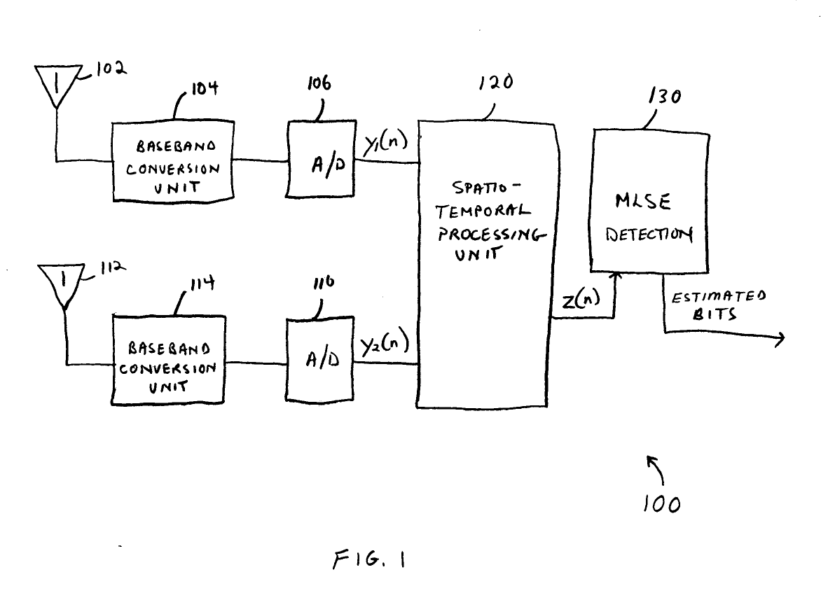

FIG. 1 shows a dual antenna receiver. Dual antenna receiver 100 includes antennas 102 and 112, baseband conversion units 104 and 114, analog-to-digital (A/D) converters 106 and 116, spatio-temporal processing unit 120, and maximum likelihood sequence estimation (MLSE) detection block 130.

Antennas 102 and 112 may be directional antennas or an omni-directional antennas. As used herein, the term omni-directional antenna refers to any antenna having a substantially uniform pattern in at least one plane. For example, in some embodiments, one or both of antennas 102 and 112 may be an omni-directional antenna such as a dipole antenna, or a quarter wave antenna. Also for example, in some embodiments, one or both of antennas 102 or 112 may be a directional antenna such as a parabolic dish antenna or a Yagi antenna.

Baseband conversion units 104 and 114 convert signals received by antennas 102 and 112 to baseband. In some embodiments, baseband conversion units 104 and 114 may include circuitry to support reception of radio frequency (RF) signals. For example, in some embodiments, baseband conversion units 104 and 114 include circuits to perform “front end” processing such as low noise amplification (LNA), filtering, frequency conversion and the like. Also for example, in some embodiments, baseband conversion circuits 104 and 114 may include clock recovery circuits, symbol timing circuits, and the like. The invention is not limited by the contents or function of baseband conversion units 104 and 114.

Analog-to-digital (A/D) converters 106 and 116 convert the baseband signals output from baseband conversion units 104 and 114 to digital sample streams. For example, the baseband signal corresponding to antenna 102 is converted to digital sample stream y₁(n), and the baseband signal corresponding to antenna 112 is converted to digital sample stream y₂(n).

Spatio-temporal processing unit 120 linearly combines the two digital sample streams y₁(n) and y₂(n). Equation 1 describes the mathematical connection between the output and the input of spatio-temporal processing unit 120.
z(n)=y₁(n) [symbol] c₁(n)+y₂(n) [symbol] c₂(n) (1)
where:
   y₁ represents the first antenna digital baseband signal;
   y₂ represents the second antenna digital baseband signal;
   c₁ represents the first antenna combining coefficients;
   c₂ represents the second antenna combining coefficients; and
   z represents the combined signal.

In some embodiments, the combining coefficients c₁ and c₂ may be the matched-filter solution (See Eq. 2, below) to equalize the channel. Equation 2 represents the optimal or near-optimal receiver when the only noise source in the system is white Gaussian noise.
c₁(n)=h₁*(−n)/σ₁²
c₂(n)=h₂*(−n)/σ₂² (2)
where:
   h₁ represents a first antenna channel estimator; and
   h₂ represents a second antenna channel estimator; and
   σ₁² represents a first antenna noise variance; and
   σ₂² represents a second antenna noise variance.

In some embodiments, the combining coefficients c₁ and c₂ may be selected to maximize the SIR (Signal to Interference Ratio), and in other embodiments c₁ and c₂ may be selected to reduce, or even minimize, the Mean Square Error (MSE). In some embodiments, MLSE detection block 130 may not be included when c₁ and c₂ are selected to reduce MSE. In still further embodiments, the coefficients c₁ and c₂ may be selected to whiten spatial and temporal interference.

Embodiments that whiten spatial and temporal interference may reduce latency in packet-based networks and enable Voice-over-Packet Networks (VoPN). For example, if the performance of a cellular network is interference-limited, meaning strong interfering signals from neighbouring basestations or other sources degrade the target signal-to-noise ratio and thus degrade the data throughput to the handset, the interfering signals may increase the packet error rate and cause a reduction in throughput. In very crowded network conditions, such as an urban area, the strong interferers may be especially dominant and can degrade throughput to the point where wireless VoPN cannot be implemented. In various embodiments of the present invention, spatio-temporal processing using a dual antenna receiver may be used to enhance interference identification and cancellation. The dual antenna receiver may detect the interfering signals by weighting them according to duration and strength, subsequently cancel out the interference, and reduce latency enough to enable wireless VoPN.

Dual antenna receiver 100 may be utilized in any environment suitable for spatio-temporal processing. For example, in some embodiments, dual antenna receiver 100 may be useful as a receiver in a packet-based network such as a General Packet Radio Service (GPRS/EGPRS) network or the like. The receiver may be employed in a handset, a base station, or any other portion of a wireless network capable of receiving signals using a dual antenna receiver.

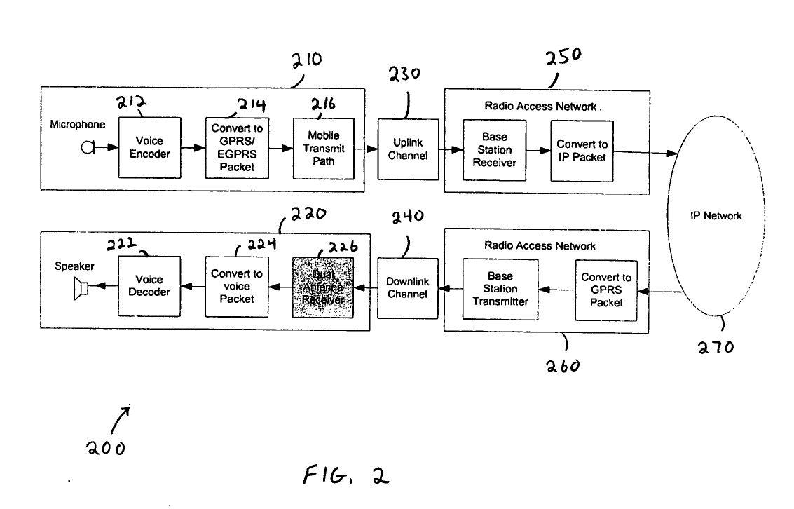

FIG. 2 shows a Voice-over-IP architecture. Architecture 200 includes mobile stations 210 and 220, and radio access networks (RANs) 250 and 260. Mobile station 210 communicates with RAN 250 through uplink channel 230, RAN 250 communicates with RAN 260 through internet protocol (IP) network 270, and RAN 260 communicates with mobile station 220 through downlink channel 240.

Architecture 200 shows voice communications in a single direction between two mobile stations. For example, mobile station 210 receives voice information from a microphone, and sends the voice information to mobile station 220, which ultimately plays the voice on a speaker. This unidirectional communication is shown for simplicity only. In some embodiments, bi-directional voice communications take place. In these embodiments, both mobile stations 210 and 220 may send and receive voice data.

Mobile stations 210 and 220 may be any type of mobile station capable of packet-based communications. For example, in some embodiments, mobile stations 210 and 220 may be cellular handsets. Also for example, in other embodiments, mobile stations 210 and 220 may be part of laptop computers or other appliances capable of working with voice signals.

In operation, the microphone in mobile station 210 converts the voice into data. Voice encoder 212 encodes data from the microphone into voice packets. The voice packets are converted into GPRS/EGPRS packets at 214. GPRS packets are prepared for transmission and transmitted by mobile transmit path 216 in mobile station 210. The GPRS packets travel through uplink channel 230 to a base station receiver in RAN 250. RAN 250 converts the received GPRS packets to IP packets and passes them through IP network 270 to RAN 260. RAN 260 converts the IP packets back to GPRS packets and transmits the GPRS packets through downlink channel 240 to mobile station 220. Mobile station 220 receives the GPRS packets using dual antenna receiver 226, which in some embodiments, uses a spatio-temporal algorithm to detect the GPRS packet with much less error than a conventional receiver. The GPRS packets are then converted to voice packets at 224, decoded by voice decoder 222 and played by the speaker.

The architecture shown in FIG. 2 utilizes a dual antenna receiver in a mobile station to increase packet-switched network capacity, and to improve its quality of service (QoS) in Packet Switching (PS), as measured by delay or latency. By improving QoS, the use of a dual antenna receiver in architecture 200 may reduce the packet delay, and enable or improve VoPN or VoIP.

In some embodiments, each receiver capable of receiving communications may include a dual antenna receiver. For example, in some embodiments, the base station receiver in RAN 250 may utilize a dual antennal receiver. Also in some embodiments, mobile station 210 and RAN 260 may include dual antenna receivers.

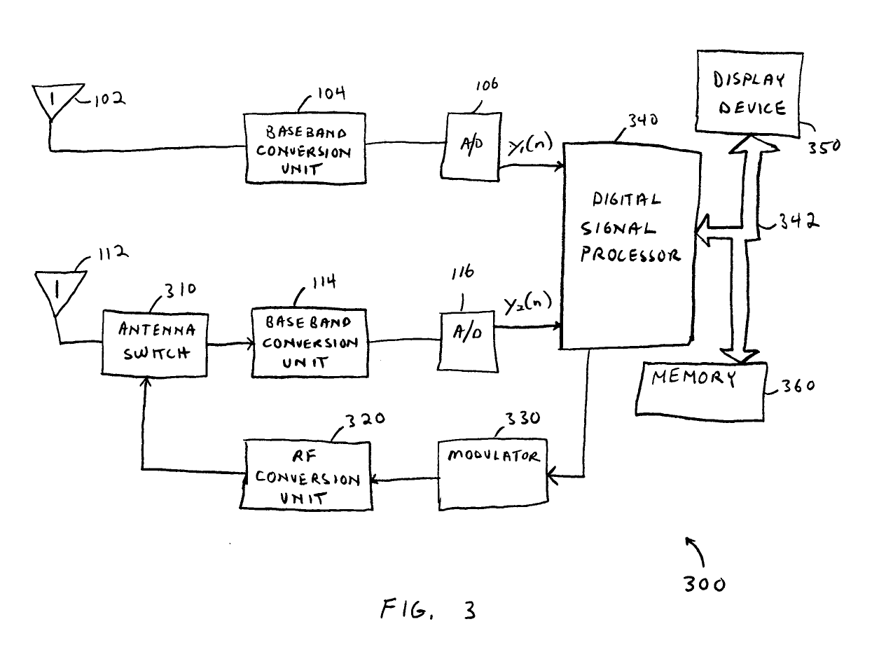

FIG. 3 shows a system diagram in accordance with various embodiments of the present invention. Electronic system 300 includes antennas 102 and 112, baseband conversion units 104 and 114, and A/D converters 106 and 116, all of which are described above with reference to FIG. 1. Electronic system 300 also includes digital signal processor (DSP) 340, display device 350, memory device 360, modulator 330, radio frequency (RF) conversion unit 320, and antenna switch 310.

Digital signal processor 340 receives the digital baseband sample streams from A/D 106 and A/D 116. In some embodiments, DSP 340 implements the spatio-temporal processing described above with reference to spatio-temporal processing unit 120 (FIG. 1). In some embodiments, DSP 340 may also implement maximum likelihood sequence estimation. As shown in FIG. 3, DSP 340 communicates with display device 350 and memory device 360 using bus 342.

Display device 350 may be any type of display device. For example, in some embodiments, display device 350 may a color display device, and in other embodiments, display device 350 may be a monochrome display device. Further, in some embodiments, display device 350 may be omitted.

Memory 360 represents an article that includes a machine readable medium. For example, memory 360 represents a random access memory (RAM), dynamic random access memory (DRAM), static random access memory (SRAM), read only memory (ROM), flash memory, or any other type of article that includes a medium readable by DSP 340. Memory 360 may store instructions for performing the execution of the various method embodiments of the present invention. Memory 360 may also store data associated with the state or operation of electronic system 300.

In some embodiments, modulator 330 receives and modulates digital information from DSP 340. The digital information modulated by modulator 330 may be voice information in the form of GPRS packets. Radio frequency (RF) conversion unit converts signals provided by modulator 330 to an appropriate frequency for transmission. For example, in some embodiments, RF conversion unit 320 may include circuits to support frequency up-conversion, and an RF transmitter. The invention is not limited by the contents or function of RF conversion unit 320.

Electronic system 300 also includes antenna switch 310 coupled between antenna 112, baseband conversion unit 114, and RF conversion unit 320. When electronic system is receiving signals, antenna switch 310 couples antenna 112 to baseband conversion unit 114, and dual antenna reception occurs as described above. When electronic system 200 is transmitting signals, antenna switch 310 couples antenna 112 to RF conversion unit 320, and antenna 112 is used as a transmitting antenna. In this manner, electronic system 300 implements a dual antenna receiver and a single antenna transmitter.

Electronic system 300 may be any system capable of including two antennas. Examples include, but are not limited to: a cellular handset, laptop computer, home audio or video appliance, or the like. Electronic system 300 may also be a mobile station in a wireless network, or may be included as a portion of a radio access network (RAN), such as RAN 250 (FIG. 2).

Dual antenna receivers, spatio-temporal processing units, and other embodiments of the present invention can be implemented in many ways. In some embodiments, they are implemented in various integrated circuits as part of a voice capable wireless appliance. In some embodiments, design descriptions of the various embodiments of the present invention are included in libraries that enable designers to include them in custom or semi-custom designs. For example, any of the disclosed embodiments can be implemented in a synthesizable hardware design language, such as VHDL or Verilog, and distributed to designers for inclusion in standard cell designs, gate arrays, or the like. Likewise, any embodiment of the present invention can also be represented as a hard macro targeted to a specific manufacturing process.

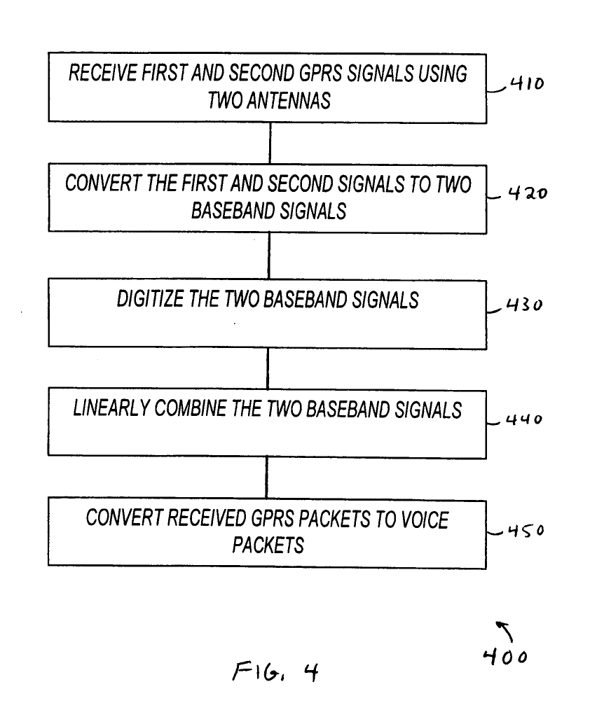

FIG. 4 shows a flowchart in accordance with various embodiments of the present invention. In some embodiments, method 400 may be used to receive voice data in a GPRS wireless network. In some embodiments, method 400, or portions thereof, is performed by a dual antenna receiver or electronic system, embodiments of which are shown in the various figures. Method 400 is not limited by the particular type of apparatus or software element performing the method. The various actions in method 400 may be performed in the order presented, or may be performed in a different order. Further, in some embodiments, some actions listed in FIG. 4 are omitted from method 400.

Method 400 is shown beginning at block 410 in which first and second GPRS signals are received using two antennas. At 420, the first and second signals are converted to two baseband signals. At 430, the two baseband signals are digitized, and at 440, the two baseband signals are linearly combined. At 450, received GPRS packets are converted to voice packets.

In some embodiments, the linear combining operation of block 440 is performed by a spatio-temporal processing unit such as spatio-temporal processing unit 120 (FIG. 1). In some embodiments the two digital baseband signals are combined using a matched-filter solution for channels associated with the two antennas. For example, combining coefficients may be selected that correspond to those shown in equation 2, above. In other embodiments, the two digital baseband signals are combined using combining coefficients selected to increase a signal to interference ratio (SIR). In some embodiments, the two digital baseband signals are combined using combining coefficients selected to reduce mean squared error (MSE). In still further embodiments, the two digital baseband signals are combined using combining coefficients selected to whiten spatial and temporal interference.

Although the present invention has been described in conjunction with certain embodiments, it is to be understood that modifications and variations may be resorted to without departing from the spirit and scope of the invention. For example, although the various embodiments of the present invention have been described using voice communications, they are equally applicable to video communications. Such modifications and variations are considered to be within the scope of the invention and the appended claims.

1. A method comprising:
receiving two signals from two antennas;
converting the two signals to baseband;
digitizing the two signals; and
linearly combining the two signals to receive voice packets.

2. The method of claim 1 further comprising transmitting using one of the two antennas.

3. The method of claim 1 wherein linearly combining comprises applying a matched-filter solution for channels associated with the two antennas.

4. The method of claim 1 wherein linearly combining comprises selecting combining coefficients to increase a signal to interference ratio (SIR).

5. The method of claim 1 wherein linearly combining comprises selecting combining coefficients to whiten spatial and temporal interference.

6. The method of claim 1 wherein linearly combining comprises selecting combining coefficients to reduce mean squared error (MSE).

7. The method of claim 1 wherein linearly combining the two signals to receive voice packets comprises:
linearly combining the two signals to form General Packet Radio Service (GPRS) packets; and
converting GPRS packets to voice packets.

8. A method comprising:
receiving first and second General Packet Radio Service (GPRS) signals using two antennas;
converting the first and second signals to two baseband signals;
digitizing the two baseband signals;
linearly combining the two baseband signals; and
converting received GPRS packets to voice packets.

9. The method of claim 8 wherein linearly combining comprises applying a matched-filter solution for channels associated with the two antennas.

10. The method of claim 8 wherein linearly combining comprises selecting combining coefficients to increase a signal to interference ratio (SIR).

11. The method of claim 8 wherein linearly combining comprises selecting combining coefficients to whiten spatial and temporal interference.

12. The method of claim 8 wherein linearly combining comprises selecting combining coefficients to reduce mean squared error (MSE).

13. An apparatus comprising:
a first antenna and a first baseband conversion unit coupled to the first antenna to produce a first baseband signal;
a first analog-to-digital converter to convert the first baseband signal into a first digital sample stream;
a second antenna and a second baseband conversion unit coupled to the second antenna to produce a second baseband signal;
a second analog-to-digital converter to convert the second baseband signal into a second digital sample stream; and
a spatio-temporal processing unit to linearly combine the first and second digital sample streams to receive a voice signal in a General Packet Radio Service (GPRS) network.

14. The apparatus of claim 13 wherein the spatio-temporal processing unit is adapted to linearly combine the first and second digital sample streams by applying a matched-filter solution for channels associated with the two antennas.

15. The apparatus of claim 13 wherein the spatio-temporal processing unit is adapted to linearly combine the first and second digital sample streams using coefficients to increase a signal to interference ratio (SIR).

16. The apparatus of claim 13 wherein the spatio-temporal processing unit is adapted to linearly combine the first and second digital sample streams using coefficients to whiten spatial and temporal interference.

17. The apparatus of claim 13 wherein the spatio-temporal processing unit is adapted to linearly combine the first and second digital sample streams using coefficients to reduce mean squared error (MSE).

18. The apparatus of claim 13 further comprising an antenna switch to transmit using one antenna.

19. An electronic system comprising:
a first antenna and a first baseband conversion unit coupled to the first antenna to produce a first baseband signal;
a first analog-to-digital converter to convert the first baseband signal into a first digital sample stream;
a second antenna and a second baseband conversion unit coupled to the second antenna to produce a second baseband signal;
a second analog-to-digital converter to convert the second baseband signal into a second digital sample stream;
a spatio-temporal processing unit to linearly combine the first and second digital sample streams to receive a voice signal in a General Packet Radio Service (GPRS) network; and
a color display device.

20. The electronic system of claim 21 wherein the spatio-temporal processing unit is adapted to linearly combine the first and second digital sample streams by applying a matched-filter solution for channels associated with the two antennas.

21. The electronic system of claim 21 wherein the spatio-temporal processing unit is adapted to linearly combine the first and second digital sample streams using coefficients to increase a signal to interference ratio (SIR).

22. The electronic system of claim 21 wherein the spatio-temporal processing unit is adapted to linearly combine the first and second digital sample streams using coefficients to whiten spatial and temporal interference.
